(19) United States
(12) Patent Application Publication
(10) Pub. No.: US 2022/0020288 A1
(43) Pub. Date: Jan. 20, 2022

(54) AUTOMATED SYSTEMS AND METHODS FOR PROCESSING COMMUNICATION PROFICIENCY DATA

(71) Applicants: Emily K. NABER, Washington, DC (US); Saman MEHRYAR, Washington, DC (US); Amirhossein SAEEDI, Richmond, VA (US)

(72) Inventors: Emily K. NABER, Washington, DC (US); Saman MEHRYAR, Washington, DC (US); Amirhossein SAEEDI, Richmond, VA (US)

(21) Appl. No.: 17/366,666

(22) Filed: Jul. 2, 2021

Related U.S. Application Data
(60) Provisional application No. 63/053,282, filed on Jul. 17, 2020.

(51) Int. Cl. G09B 19/04; G06F 16/245; G10L 15/187; G10L 15/22; G09B 7/02; G09B 7/06

(52) U.S. Cl. CPC G09B 19/04; G06F 16/245; G10L 15/187; G09B 19/06; G09B 7/02; G09B 7/06; G10L 2015/225; G10L 15/22

(57) ABSTRACT

A method for enabling improved proficiency of speech, which may have the steps of: receiving language sample input from a regular user; facilitating analysis of the language sample input by implementing a machine learning model trained using a scoring agent based on a pre-determined set of language parameters to generate a coaching score; receiving a coaching score input from the scoring agent analysis of the user's speech proficiency; generating a report to the user resulting from applying the previously-trained machine learning model based on the score, wherein the report is configured to enable the user to improve speech proficiency. In another embodiment, the scoring agent may be at least one of a human, a regular user, or a machine with the ability to analyze the user audio input based on the set of language parameters.

### FIELD

The present invention relates, generally, to automated language proficiency improvement systems and methods and, more particularly, to the processing, storage, adjustment by machine learning and delivery of data, such as feedback, generated by such systems.

### BACKGROUND

Proficient communication by spoken language involves more than a broad vocabulary used with proper grammar. There also exists a desire and need for people to speak with understandable and accurate pronunciation. This can include minimalizing a perceived accent, phoneme accuracy, and the like. Achieving a “native” level fluency of speech proficiency can be particularly challenging especially for a person learning a new language. Improving a person's speech proficiency usually requires large amounts of time, feedback, and practice. In the past, this has been preferably enabled with the help of personal training from a skilled teacher. However, the expense of this type of personal training can make this learning environment prohibitively expensive.

One solution in the art to enable improved language proficiency is to attempt automated systems to provide some nominal level of machine generated feedback based on a user's sample language input. Other solutions in the art may provide a platform to facilitate human feedback on the user's language input. (See generally, U.S. Pat. Nos. 5,679,001; 10,628,531; WO 2013172707A2; JP4189051B2 and JP2007057844A)

Despite these advances, further improvements are desired.

### SUMMARY

The present invention relates, generally, to automated language proficiency improvement systems and methods and, more particularly, to the processing, storage, adjustment by machine learning and delivery of data, such as feedback, generated by such systems.

The present embodiments generally relate to automated applications, systems, and methods to enable improvement of a users' language proficiency, and particularly to enable improvement of a users' language proficiency by providing preselected educational content, receiving input from a user based on their selected educational content, analyzing the input with pre-determined speech recognition parameters and generating feedback via at least one of the system's pre-selected algorithms and/or alternately by providing feedback generated from other pre-determined users of the system. The present embodiments also provide supervised adjustments to the system's algorithms by machine learning using analyzed inputs accumulated from interactions of system users.

The presented embodiments can result in improved user language proficiency using automated and adaptable systems using machine learning and artificial intelligence which can significantly improve language proficiency, which are closer to a personal teacher experience than previously known in the art.

In one approach, exemplary applications connect the user with scoring agents to provide feedback on the user's language input. The scoring agent may also provide inputs to improve system analysis.

In one approach, exemplary applications may provide options to enable saving, printing and editing the content and the transcripts of a user session.

In one approach, exemplary applications may provide system details capable of handling an accent of a user using phonemes.

A method for enabling improved proficiency of speech is provided, which may have the steps of: receiving language sample input from a regular user; facilitating analysis of the language sample input by implementing a machine learning model trained using a scoring agent based on a pre-determined set of language parameters to generate a coaching score; receiving a coaching score input from the scoring agent analysis of the user's speech proficiency; generating a report to the user resulting from applying the previously-trained machine learning model based on the score, wherein the report is configured to enable the user to improve speech proficiency. In another embodiment, the scoring agent may be at least one of a human, a regular user, and/or a machine with the ability to analyze the user audio input based on the set of language parameters.

In another approach, a method for enabling improved proficiency of speech is provided having the steps of receiving language sample input from a regular user; facilitating analysis of the language sample input by a scoring agent based on a pre-determined set of language parameters to generate a coaching score; receiving a coaching score input from the scoring agent analysis of the user's speech proficiency; generating a report to the user based on the score, wherein the report is configured to enable the user to improve speech proficiency; wherein the scoring agent is at least one of a human, a regular user, and a machine with the ability to analyze the user audio input based on the set of language parameters.

In one approach the language parameters may have at least one of accuracy of a phoneme, word stress, sentence stress, intonation, and an appropriateness indicator of a phrase in a sentence or that paragraph based on the context.

In one approach, the step of receiving a language sample, may be one of recording a repeated single preselected word, repeating a pre-determined text of multiple words, and answering a preselected question using at least one of a camera and a microphone.

In one approach, the step of displaying preselected education content in response to receiving a language sample from the user; initiating a module to provide a user educational content; and initiating a module to provide a user practice activities may be included.

In one approach, the step of launching a preselected practice activity comprising the steps of playing a preselected language sample to a user; prompting user to record a comparable language sample; and facilitating a user to compare their sample with the preselected sample may be included.

In one approach, the step of launching a preselected quiz activity comprising the steps of generating at least one preselected quiz item which includes a question and an array of possible answers; receiving a user's response to the quiz item; comparing the response with the answer in a system database; recording the response; and allowing a user to become a scoring agent within the system if a pre-determined quantity and proportion of correct answers are recorded may be included.

In one approach, the scoring agent may be a machine learning algorithm that may have the steps of analyzing the language sample; generating and providing a report of the analysis to the user; and allowing the user to record a new language sample for a new analysis for the user generates a report and gives the user an option to repeat the language sample.

In one approach, the facilitating analysis of the language sample input by a scoring agent based on a pre-determined set of language parameters may include the steps of scoring agent assigning a coaching score to the data from the language sample according their analysis of performance in pre-determined performance indicators; the scoring agent assigning a coaching score to each post-lesson assignment based on the level of improvement between the pre-lesson and post-lesson language input samples of at least one of the same context and same word; the scoring agent providing the user a report to the user containing the scoring agent's analysis; and the scoring agent notifying the user that feedback has been provided.

In one approach, the step of qualifying a user to become a scoring agent by reaching a quantitative pre-determined threshold of performance-related data; and assigning a weighting factor to a scoring agent who has reached the pre-determined threshold of performance based on the value (high or low) of their cumulative score beyond reaching the threshold may be included.

In one approach, the step of receiving language sample input from a regular user may have at least one of the steps of generating phonemes from a language sample received as a written text; using speech recognition software to generate the text associated with the language sample; and providing a scoring mechanism agent to input text associated with the language sample.

In one approach, the step of generating the coaching score may include analyses of a likelihood score of each phenome, user input, input from a training database, and demographic information provided about the user.

In one approach, the provided demographic information of the user may include at least one of native language of the user, age, and gender.

In one approach, the step of the step of improving coaching scores system-wide by within a training database comparing the user input, system generated likelihood score and coaching score to determine best algorithm for matching likelihood score and coaching score may be provided.

Other aspects and features of the embodiments herein will become apparent to those ordinarily skilled in the art upon review of the following description of specific embodiments in conjunction with the accompanying figures.

### BRIEF DESCRIPTION OF THE DRAWINGS

FIG. 1 illustrates a flow diagram of an overview of an exemplary system application of the present embodiments.

FIG. 2a illustrates a flow diagram of an exemplary first language sample collection and educational content delivery portions of the present embodiments of area II in FIG. 1.

FIG. 2b illustrates a flow diagram of an exemplary structure of an interactive practice in which the system generates a premade language sample and solicits a comparable sample from the learner according to one approach of the present embodiments of area II in FIG. 1.

FIG. 2c illustrates a flow diagram of an exemplary interactive quiz portion of a module according to one approach of the present embodiments of area II in FIG. 1. (See also, area II-C in FIG. 3).

FIG. 2d illustrates a flow diagram of an exemplary another interactive practice portion of a module in which the system solicits language samples from the learners, sends them to the server unit for analysis, and displays a report to the learner according to one approach of the present embodiments of area II in FIG. 1.

FIG. 2e illustrates a flow diagram of an exemplary section of the module where the system may depicts additional educational content and related interactive practice activities according to one approach of the present embodiments of area II in FIG. 1.

FIG. 2f illustrates a flow diagram of an exemplary approach of how a language sample may be collected and sent to a server unit after the system delivers educational content and practice activities according to one approach of the present embodiments of area II in FIG. 1.

FIG. 2g illustrates a flow diagram of an exemplary process of area II-g of FIG. 2f of by which the system may facilitate data labeling by a scoring agent, storing the data in a server unit, and sending feedback to a learner according to one approach of the present embodiments of area II in FIG. 1.

FIG. 3 illustrates a flow diagram of an exemplary approach of area III of FIG. 2c of how the system may facilitate learner labeling and determination of eligibility to be a scorer based on their performance in the quiz section of the module according to one approach of the present embodiments.

FIG. 4 illustrates a flow diagram of an exemplary approach of how the system may analyze the language sample submitted, as referenced in area IV of FIG. 2d, and generates a report to send the learner according to one approach of the present embodiments.

FIG. 5 illustrates a flow diagram of an exemplary approach of how the system may receive and incorporate data from a scoring agent into its future analyses according to one approach of the present embodiments.

FIG. 6 illustrates a flow diagram of an exemplary approach of how the system may receive and incorporate data from the scoring agent into generating a comparative analysis of language samples according to one approach of the present embodiments.

FIG. 7 illustrates an overview of the system architecture according to one approach of the present embodiments.

FIG. 8 illustrates an exemplary prompt for learner language input collection according to one approach of the present embodiments.

FIG. 9 illustrates an exemplary prompt for learner language input collection according to one approach of the present embodiments.

FIG. 10 illustrates an exemplary feedback report of the present embodiments as seen by the learner.

FIG. 11 illustrates an exemplary prompt of Interface for Scoring Agent according to one approach of the present embodiments.

FIG. 12 illustrates an exemplary architecture of an exemplary system device for communicating with the system server unit according to one approach of the present embodiments.

FIG. 13 illustrates an exemplary login screen screenshot according to one approach of the present embodiments.

FIG. 14 illustrates an exemplary learner data input screen according to one approach of the present embodiments.

FIG. 15 illustrates an exemplary general architecture of an exemplary system device for communicating with the system server unit according to one approach of the present embodiments.

FIG. 16 illustrates a screen for the smart coach according to one approach of the present embodiments.

FIG. 17 illustrates an automatic process of generating a performance score for a learner based on their accuracy in evaluating their own language samples. The process is carried out automatically while a user completes the steps illustrated by area XVII in FIG. 2b.

FIG. 18 illustrates the automatic process by which the system selects feedback from a database to be used to generate a feedback report that is sent to the learner illustrated by area XVIII in FIG. 4.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents, and alternatives falling within the spirit and scope of the subject matter as defined by the appended claims.

### DETAILED DESCRIPTION

The present embodiments generally relate to automated applications, systems, and methods to enable improvement of a learners' language proficiency, and particularly to enable improvement of a learners' language proficiency by providing preselected educational content, receiving input from a learner based on their selected educational content, analyzing the input with pre-determined speech recognition parameters and generating feedback via at least one of the system's pre-selected algorithms and/or alternately by providing feedback from other pre-determined users of the system. The present embodiments may also provide supervised adjustments to the system's algorithms using analyzed inputs accumulated from interactions of system users using machine learning.

The present embodiments may be used on mobile devices, computers, and laptops to educate the users on their language skills by providing educational content in the form of media and text, receiving input from the users, and providing them feedback from the systems algorithm and also by other users of the system. The system also provides a new method for supervised training of machine algorithms by using the inputs and the interactions of the system users.

The embodiments described herein are, in some instances, described as a sequence of steps. This was done solely for the sake of illustration. Accordingly, it is contemplated that some steps may be added, some steps may be omitted, the order of the steps may be re-arranged, or some steps may be performed simultaneously. The exemplary embodiments described herein may be implemented in an operating environment comprising software installed on a computer, in hardware, or in a combination of software and hardware.

To assist in the understanding of the present embodiments, an exemplary glossary of some of the terms used herein is provided as follows:
Training database: is a database that includes a variety of language samples with associated coaching scores (see below), which are preconfigured by scoring agents and/or as modified by an adjustment based on machine learning from analyzed inputs accumulated from interactions of system users.
Coaching score: is a quantitative and/or qualitative indicator that represents the level of correctness of the measured language parameter, such as (for illustrative purposes only) a quantitative and/or a qualitative indicator that represents the accuracy of a phoneme, word stress, sentence stress, intonation, and/or an indicator of the appropriateness of a phrase in a sentence or that paragraph based on the context.
Likelihood score: is a quantitative score that shows the level of similarity of language sample with the reference language data.
Scoring agent: is identified by the system to provide a score or feedback to a learner's language input and may be any user of the system or any machine with the pre-determined machine learning capabilities, the scoring agent may be by human, machine learning or a combination of both.
Machine learning: is the scientific study of algorithms and statistical models that computer systems use to carry out tasks without explicit instructions, such as by using pattern recognition and inference. A “machine learning” model is used, without loss of generality, to refer to any result of an analysis method that is designed to make some form of prediction, such as predicting the state of a response variable, clustering users, determining association rules, and performing anomaly detection. Thus, for example, the term “machine learning” refers to models that undergo supervised, unsupervised, semi-supervised, and/or reinforcement learning. Such models may perform classification (e.g., binary or multiclass classification), regression, clustering, dimensionality reduction, and/or such tasks. Examples of such models include, without limitation, artificial neural networks (ANN) (such as a recurrent neural networks (RNN) and convolutional neural network (CNN)), decision tree models (such as classification and regression trees (CART)), ensemble learning models (such as boosting, bootstrapped aggregation, gradient boosting machines, and random forests), Bayesian network models (e.g., naive Bayes), principal component analysis (PCA), support vector machines (SVM), clustering models (such as K-nearest-neighbor, K-means, expectation maximization, hierarchical clustering, etc.), linear discriminant analysis models.
Learner: the human benefiting from the system to improve their language efficiency; used in the description when the system is functioning specifically for educational purposes.
User: a human involved in the system in any way; used in the description when the human referenced could be a learner, a coach or any other human involved with the system.
Screen: the electronic visual display system of a computing device, enabling a user to view images.
Client interface software: a software to provide the user interface of the system on a device and also communicate with the server unit of the system by internet, such as a mobile app for Android or iOS platform an application for Windows or a website to use with a web browser.
Feedback generating module: an element of the system that contains pre-determined information that can be used in combination with the coaching scores to generate automated feedback that is sent to a learner.
Feedback report: a report that is sent to the user and contains a numerical coaching score as well as qualitative feedback automatically generated by the system.

According to one approach, the present embodiments operate as a cloud-based software. The system includes clients' apps on different platforms such as Android, IOS, web browsers, and the like. Client interface software is software to provide the user interface of the system on a device and also communicate with the server unit of the system by internet, such as a mobile app for Android or iOS platform, an application for Windows or a website to use with a web browser.

In general, the present embodiments can be realized as methods or systems in hardware, software, or a combination of hardware and software of a computing device system, including a computing device network system. The present embodiments can be realized in a centralized fashion in one computing device system or in a distributed fashion where different elements are spread across several computing device systems. Any kind of computer system, or other apparatus adapted for carrying out the methods described herein, is suitable. A typical combination of hardware and software may include a general-purpose computer system with a computer program that, when being loaded and executed, controls the computer system such that it carries out the systems and methods described herein. The present embodiments may be voluntarily embedded in a computing device program product (or any computing device useable medium having computer readable program code embodied therein), which comprises all the features enabling the implementation of the methods and systems described herein and which when loaded in a computing device system is able to carry out these systems and methods.

In some embodiments, the system provides a text to the learner, and the learner enters a language input based on that text. Then the system uses the learner input and the text for analysis in the next steps.

In some embodiments, the system provides a media in the form of an image, video, or audio to a learner. At the same time, there is a pre-defined text associated with the media recorded in the system. The learner enters an input based on the supplied media. Then the system uses the learner input and the text for analysis in the next steps.

In some embodiments, the system receives learner input and uses speech recognition software to generate the text associated with the learner input. Then the system uses the learner input and the generated text for analysis in the next steps.

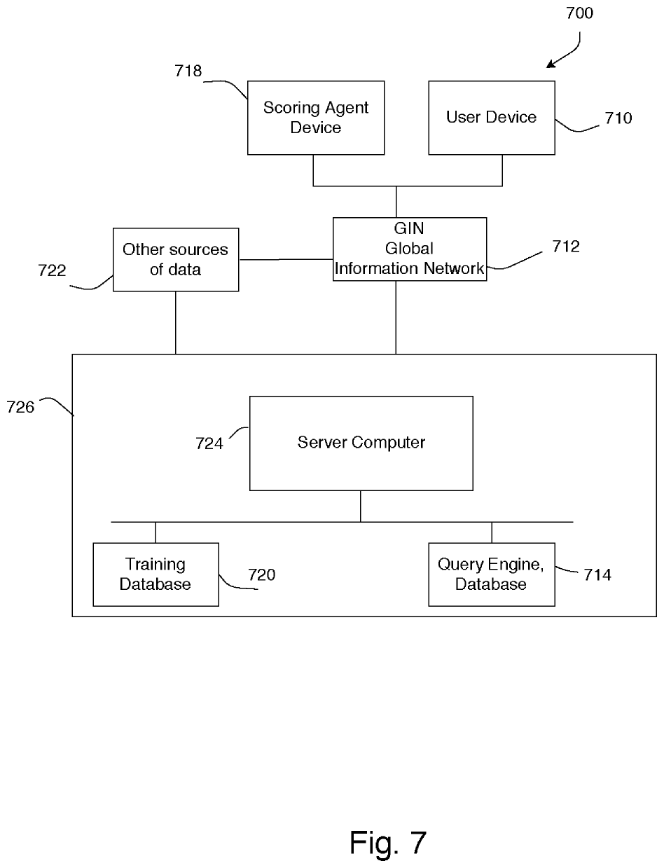

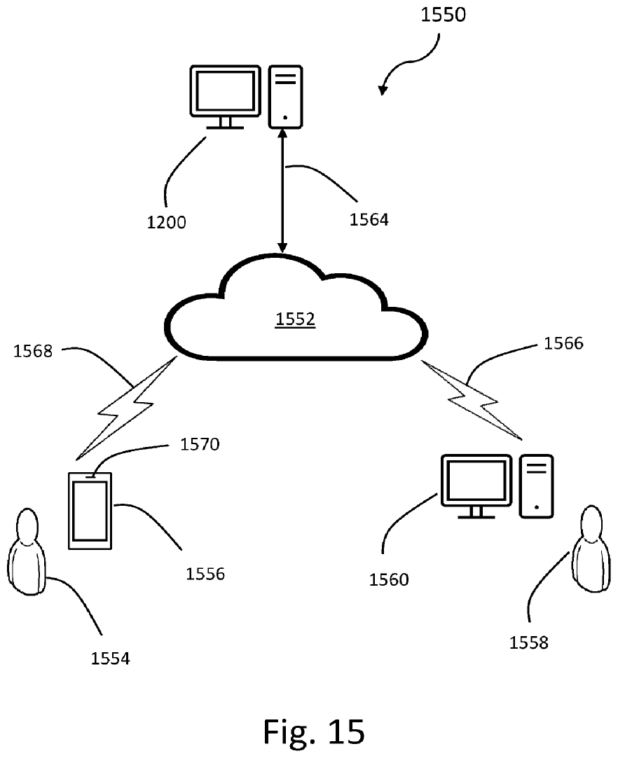

Referring to FIG. 15, an exemplary general architecture of an exemplary system 1550 for enabling improved speech proficiency is provided. FIG. 7, as discussed herein provides a more specific exemplary architecture. System 1550 as shown includes an exemplary device 1556 for use by learner 1554 and an exemplary device 1560 for use by coach 1558. Devices 1556 and 1560 can be smartphones, tablets, notebooks, laptops, wearable devices and desktop computers, among other such devices. A system application module may be disposed in server 1200 or on devices 1556 and 1560, in whole or in part or in combination. Communication interface 1564 connects server 1200 to network 1552. Communication interface 1566 connects server device 1558 to network 1552. Communication interface 1568 connects device 1554 to network 1552. The communication interface may be any of wired and wireless connections known in the art.

The system 1550 may be implemented using any handheld portable devices 1556 or 1560 capable of communication. Alternatively, system 1550 may be implemented using any non-portable devices 1556 or 1560 capable of communication. Devices 1556 and 1560 of system 1550 may include operating systems, software and application programs, web browsers such as those under the tradename GOOGLE CHROME and FIREFOX, among others, that may make the device suitable for running at least a portion of the application module on the device. It is noted that although only one learner 1554 and one coach 1558 are illustrated, the system is configured to provide multiple users (learners/coaches/administrators) using multiple devices.

The present devices of system 1550 include processors, which return output by accepting signals, such as electrical signals as input. In one embodiment, processors may include one or more processing units (CPUs). The processor(s) may communicate with a number of peripheral devices, such as, the audio input device, such as a microphone and/or camera 1570 and other device(s), via, for example, bus system, wired or wireless communication network. The devices may also be configured to communicate with remote devices via its communication interface.

The devices may include memory that may store data and program instructions that are loadable and executable on processor(s) as well as data generated during the execution of these programs. The memory may be volatile, such as random-access memory and/or a disk drive or non-volatile memory.

The devices may host a portion of the application module. A portion of the application module may also be available in the remote server 1200. The application module includes computer-executable instructions, firmware, or combinations thereof. Computer-executable instruction or firmware implementations may include computer-executable or machine-executable instructions written in any suitable programming language to perform the various functions described.

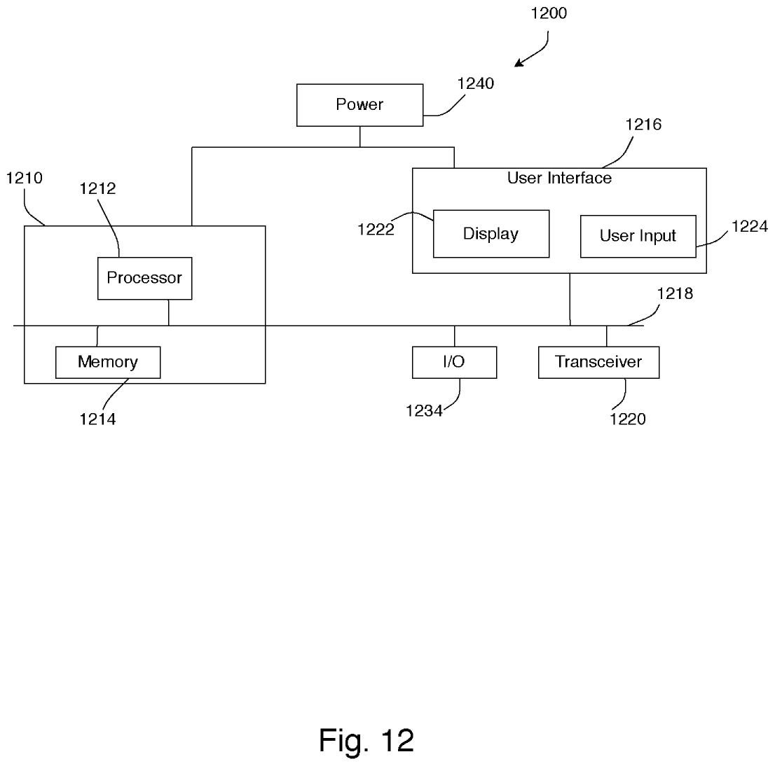

FIG. 12 illustrates an exemplary server 1220 configured for use within the system 1550, e.g., server unit 1200 or devices 1568 and 1560 according to one approach of the present embodiments. Again, it is noted that the hardware description below may apply to both the server and user interface devices. As such, one or more components of server 1200 and devices may be used for implementing any functionality, apparatus or devices mentioned above or below, or parts of such apparatuses or devices, such as for example any of the above or below mentioned computing device.

In some embodiments, the exemplary devices (e.g., such as device 1556 and 1560) and server 1200 may comprise a controller 1210 and/or processor module 1212, memory 1214, and one or more communication links, paths, buses or the like link 1218. In some embodiments, the devices and server 1200 include a user interface 1216 and/or a power source or supply 1240. The controller 1210 may be implemented through one or more processors, microprocessors, central processing unit, logic, local digital storage, firmware, software, and/or other control hardware and/or software, and may be used to execute or assist in executing the steps of the processes, methods, functionality, and techniques described herein, and control various communications, programs, content, listings, services, interfaces, logging, reporting, etc. Further, in some embodiments, the processor module 1212 can be part of control system 1210, which may be implemented through one or more processors with access to one or more memory 1214. In some aspects, the user interface 1216 allows a user to interact with the device and/or server 1200 and receive information through the system. In some embodiments, the user interface 1216 includes a display 1222 and/or one or more user inputs 1224, such as a buttons, touch screen, trackball, keyboard, mouse, microphone, camera etc., which can be part of or wired or wirelessly coupled with the device or server 1200.

In the exemplary embodiment shown in FIG. 12, the devices and server 1200 further include one or more communication interfaces, ports, transceivers 1220, and the like allowing the devices and server 1200 to communication over a communication bus, a distributed network, a local network, the Internet, communication link 1218, other networks or communication channels with other devices and/or other such communications or combinations thereof. Further, in some aspects, the transceiver 1220 is configured for wired, wireless, optical, fiber optical cable or other such communication configurations or combinations of such communications. Some embodiments include one or more input/output (I/O) ports 1234 that allow one or more devices to couple with the device 1200. The I/O ports can be substantially any relevant port or combinations of ports, such as but not limited to USB, Ethernet, or other such ports.

In some embodiments, a device such as an external microphone, camera, etc. may be connected to the device through the I/O port 1234.

The devices and server 1200 can have, by example, of a control and/or processor-based system with the controller module 1210. Again, the controller module 1210 can be implemented through one or more processors, controllers, central processing units, logic, software and the like. Further, in some implementations the controller module 1210 may provide multiprocessor functionality by including multiple processors 1212.

In some embodiments, memory 1214, which can be accessed by processor 1212 of controller module 1210, may include one or more processor readable and/or computer readable media accessed by at least the controller 1210, and can include volatile and/or nonvolatile media, such as RAM, ROM, EEPROM, flash memory and/or other memory technology.

Further, the memory 1214 is shown as internal to the controller module 1210; however, the memory 1214 can be internal, external or a combination of internal and external memory. Similarly, some or all of the memory 1214 can be internal, external or a combination of internal and external memory of the controller module 1210. The external memory can be substantially any relevant memory such as, but not limited to, one or more of flash memory secure digital (SD) card, universal serial bus (USB) stick or drive, other memory cards, hard drive and other such memory or combinations of such memory. The memory 1214 can store code, software, executables, scripts, data, content, lists, programming, programs, log or history data, user information, and the like.

The application module within the embodiments presented herein may provide a user interface on the devices that may enable communication with the application module. The user interface of the devices may enable a user, such as a coach or assistant, to provide information and analysis.

FIG. 7 illustrates an exemplary architecture of a system that may be used for many such implementations in accordance with some embodiments. One or more components of system 700 may be used for implementing any functionality or system mentioned above or below, or parts of such system, such as for example any of the above or below mentioned system.

In some embodiments, the exemplary system 700 may comprise a user device 710 and/or a scoring agent device 718. In some embodiments, scoring agent device and user device are the same devices.

System 700 may comprise a server unit 726 communicatively connected as shown in FIG. 7. In some embodiments, the server unit 726 may comprise a server computer 724, having a query engine database 714, and training database 720. In some embodiments, there is a cluster of server computers communicating as unit together. In some embodiments, the server unit 726 is grouped as one device. In some other embodiments, the elements of the server unit may be connected by a local network or a global information network such as internet. In some other embodiments the server unit is using cloud-based hardware and software.

In some embodiments, the system comprises other sources of data 722, such as digital databases such as dictionaries, language databases, databases of language associated media, and the like and combinations thereof. In some embodiments, other databases 722, the devices 718 and/or 710 use a global information network 712 to connect the server unit. In some other embodiments, 722, 718, and 710 connect directly to the server unit.

The learners and scoring agents may use devices such as a smartphone, laptop, desktop computer, or a tablet to connect to the system server unit 726 using their client software. In some embodiments, the device communicates directly to the system server unit by using third party software such as a web browser to the server unit.

Turning now to the present application module within system 1550, generally, there are two groups of potential users of system 1550. The regular users (e.g., learners) are the users who want to take advantage of the system to improve their language proficiency. There is also a group of scoring agent users (e.g., coaches) who can provide scores or feedback on the language/audio input of regular users. A scoring agent is an agent who can provide a score or feedback to a language input which can be a human, any user of the system or any machine with the mentioned ability.

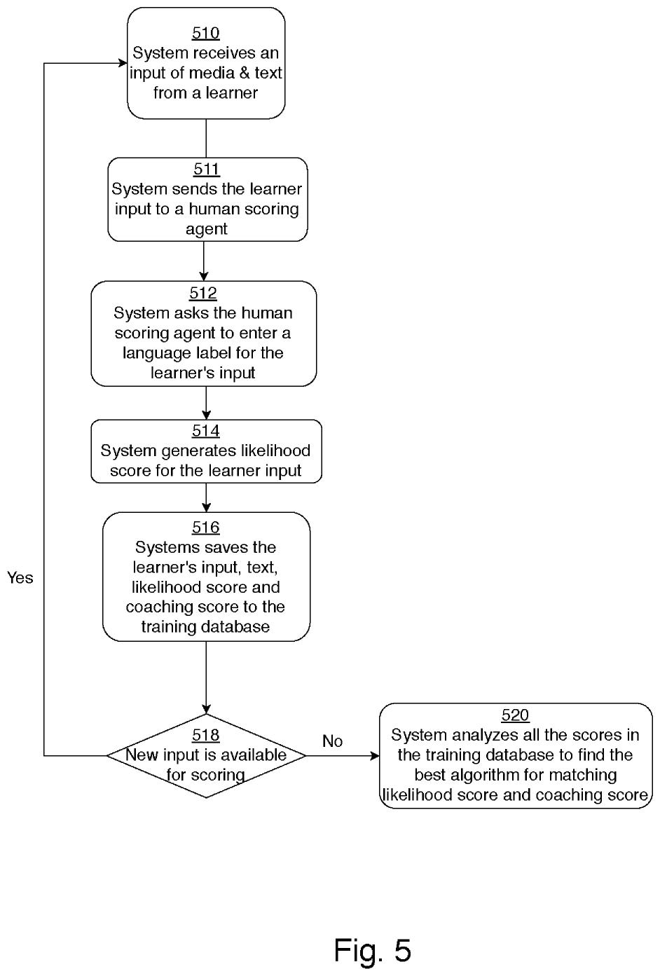

In one approach, a scoring agent is a human and according to another approach the scoring agent can be a machine who provides scores and feedback on language inputs, as explained in herein such as FIG. 5. In another approach, a scoring agent may be a regular user of the app who is accepted within the system to act as a scoring agent at the same time and is providing scores or feedback on language inputs of the other users of the system or themselves.

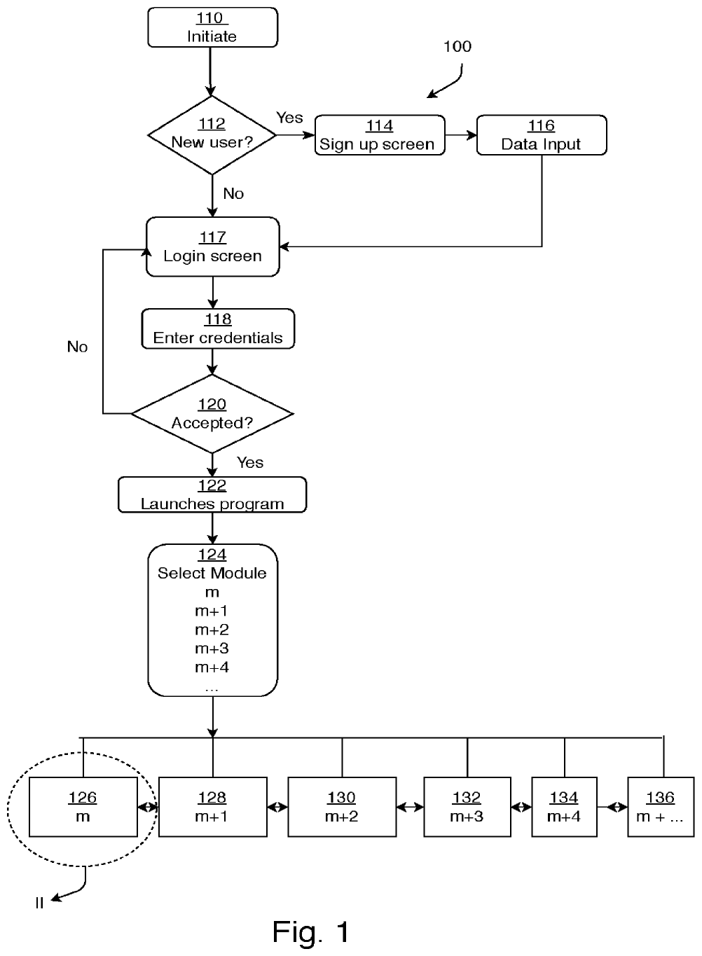

An exemplary application module of the present embodiments is shown as system 100 in FIG. 1 for illustrative purposes. In this embodiment, system 100 is initiated in step 110 and proceeds to step 112 where it prompts a user to indicate whether they are a “New User”. If the user inputs “yes” at step 112, the system proceeds to step 114 where a sign-up screen is displayed requesting the user to provide input at step 116 from a pre-determined array of data types, such as for example, e-mail, user name, password, billing information, gender, age, native language, regional dialect, other languages spoken, history of learning English, history of learning other languages, places of current and previous residence, history of speech disorder (e.g., stuttering, lisp, and the like), the average speech sentiment type, and the like and combinations thereof. Once the user has entered the minimal amount of entries required by the system to login, it proceeds to a login screen at step 117.

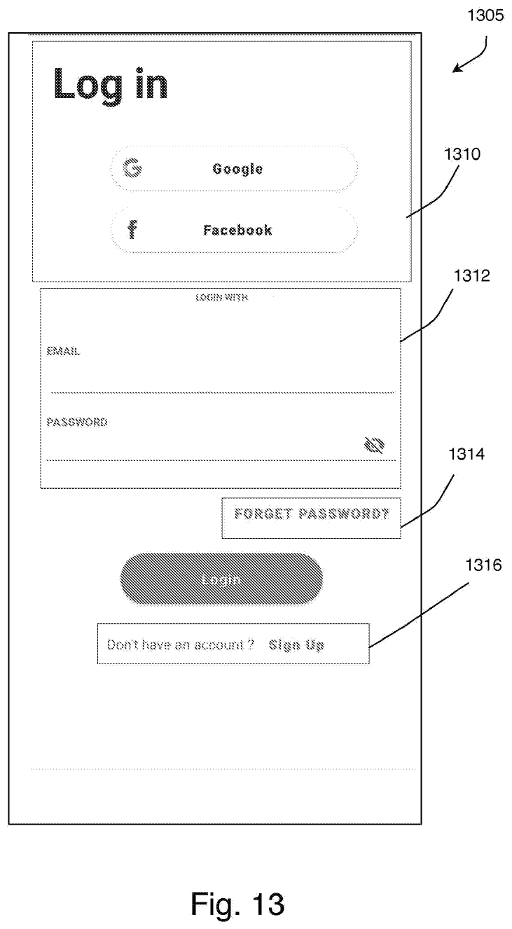

Alternately, if the user selects “no” at step 112, the system proceeds to login screen 117. At step 117 the system prompts the user to enter credentials to launch the application. An exemplary login screen 1305 is found in FIG. 13. Credentials may include username, e-mail, password and the like and combinations thereof.

As shown in FIG. 13, the user may choose to login to the system with a pre-registered third party account 1310 (such as those under the service name GOOGLE or FACEBOOK) or enter login credential as illustrated at 1312 from a pre-determined selection of items to input, which may include email address and password and the like. The login screen may include a forgot password section for users to retrieve their password at 1314. The user may optionally choose to create a new account by using the sign-up option at step 1316.

Once the system has received the request login information the system compares the entered information with pre-existing database and proceeds to step 120 to determine if the credentials are accepted. If the system accepts the user's entered credentials, the system proceeds to step 122 and launches the application. If the credentials are not accepted at step 120, the system redirects the user back to step 117. In another approach, where login credentials are not requested, the system may proceed to step 122 upon initiation 110 of the system.

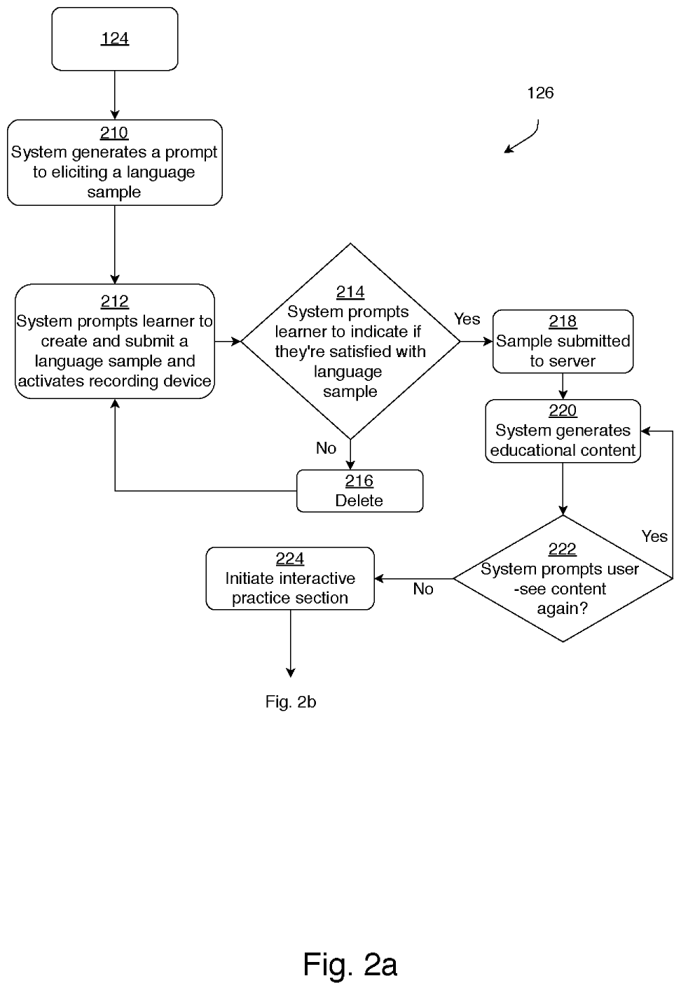

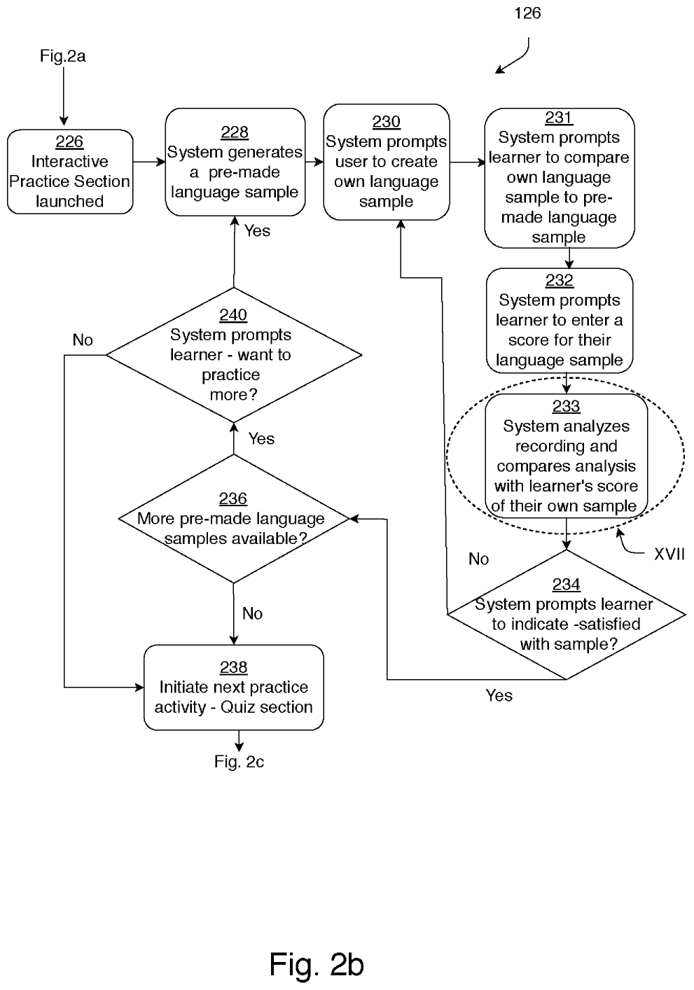

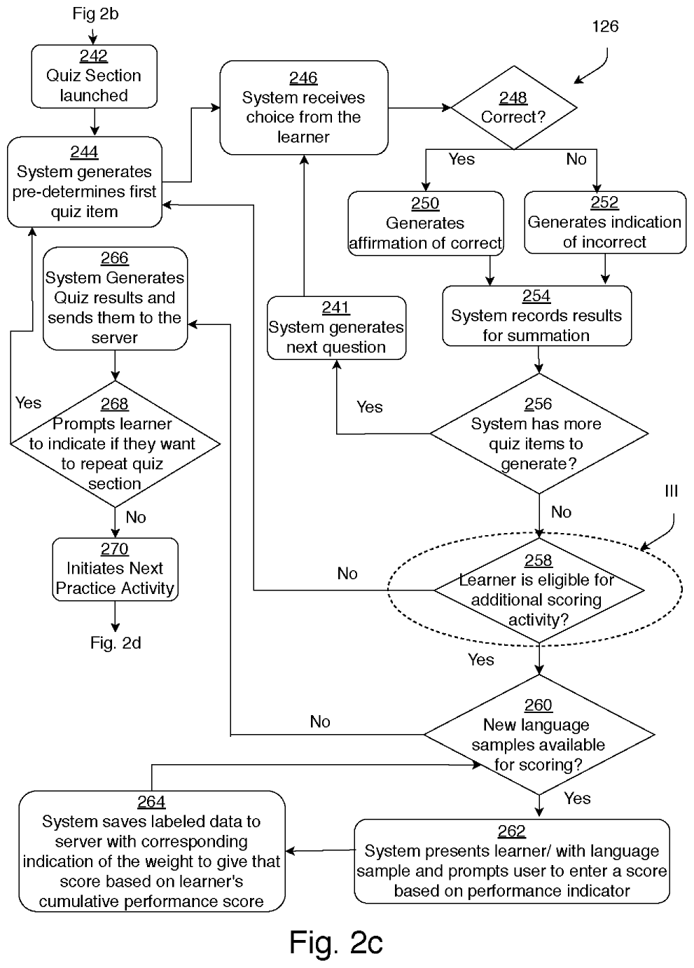

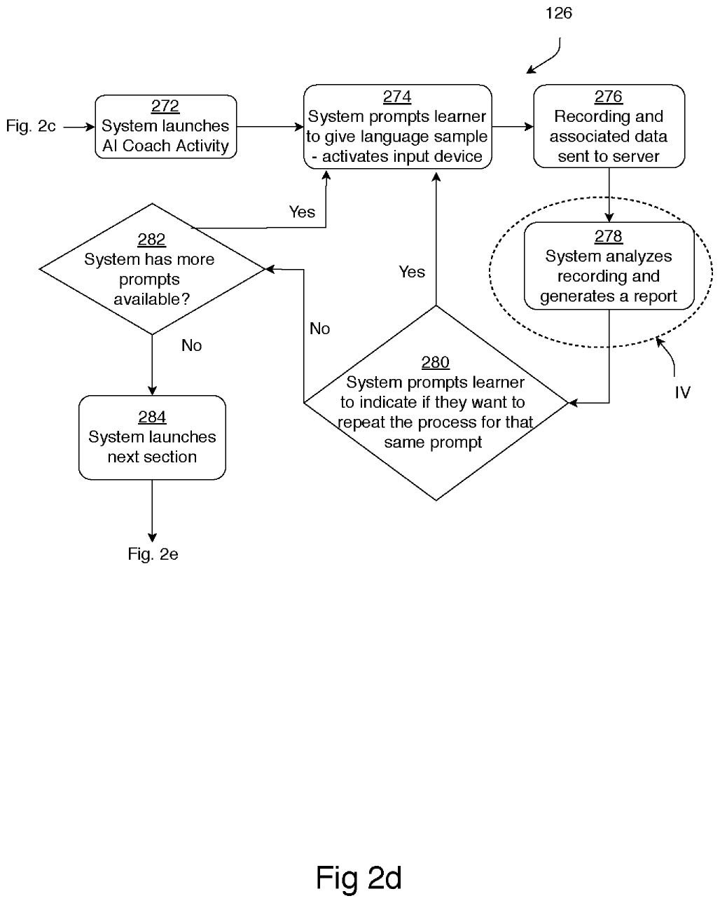

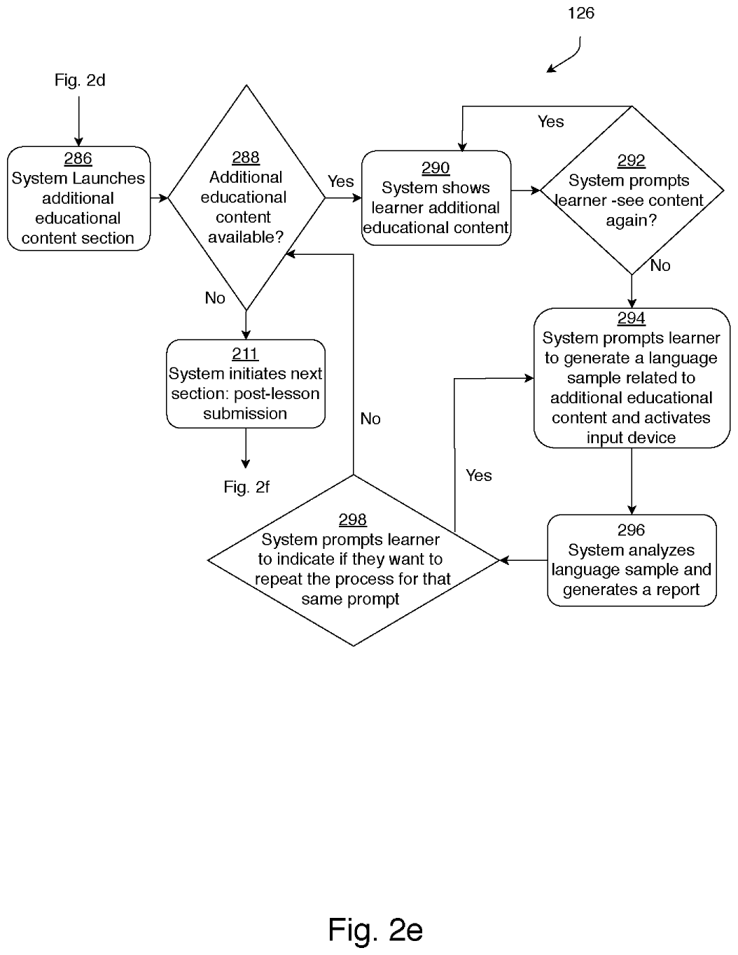

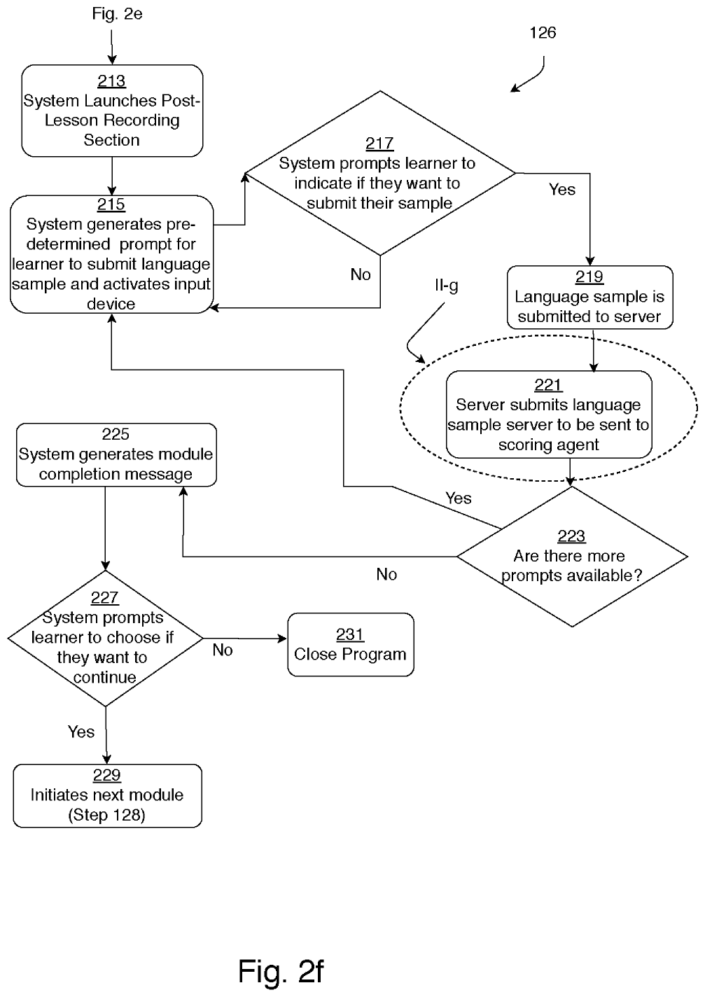

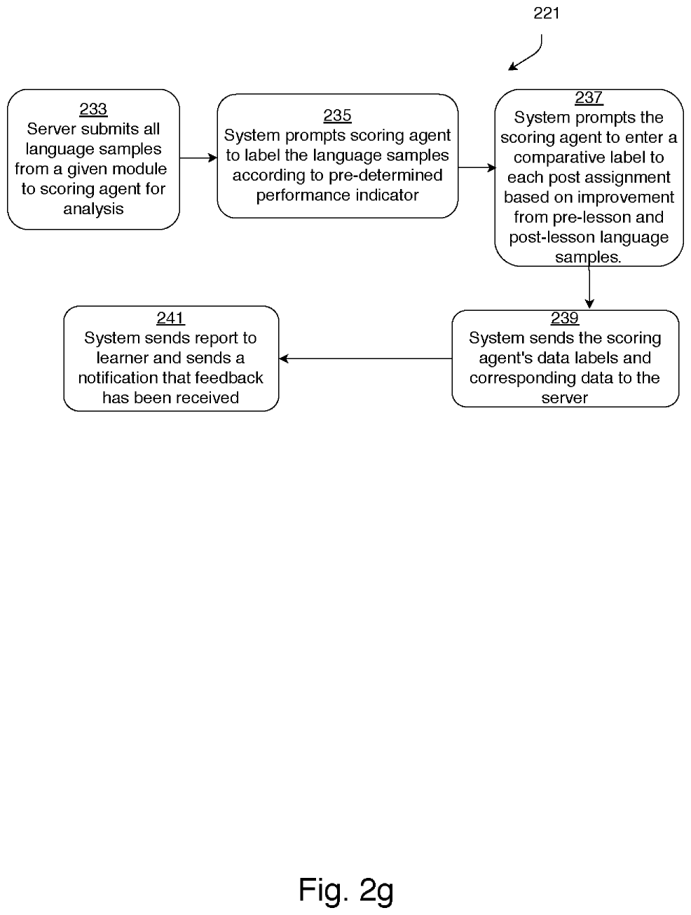

As shown in FIG. 1, after the system is launched at step 122, it proceeds to step 124 where the learner is prompted to select a module from a list displayed. As shown in FIG. 1, the system list of representative modules as 126, 128, 130, 132, 134, and 136. It is understood that the program may have multiple modules, with some exemplary modules discussed in the flow diagrams of FIG. 2a-2g as to module 126. The content of the modules of the present embodiments may be used to include educational materials and topics related to a multitude of skills a learner might want to improve. Exemplary educational training materials within these modules may be configured to (but are not limited to) assist a learner to improve their: language skills, pronunciation of phonemes from a target language, use prosodic elements of a target language such as word stress and intonation, use of regional dialects, communication and public speaking skills. The present embodiments may also be configured to assist a learner to improve their: writing skills, sentence synthesis, syntax skills, grammar skills, vocal skills (e.g., singing skills), communication skills through body language or facial gestures, musical instrument skills, dancing skills, acting skills, performance art skills, lip reading skills, test-taking skills, dating skills, business skills, computer programming language, and the like.

It should also be understood that the purpose of using modules in the system is to group similar actions, content, and tools. In another approach, these sections may be organized in a different way. As an example, all of the educational content of the system may be organized in one place, and the feedback generating sections may be organized to be in one place together. It should also be understood that the user can choose to exit the program during any step.

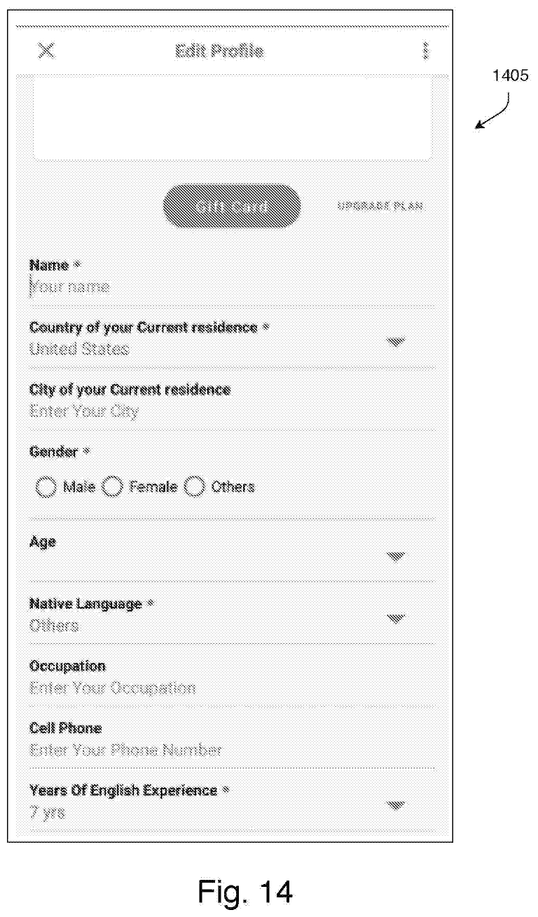

When a user logins to the system for the first time, the system may require the user to input their demographic data (such as a such as name, country of residence, city of residence, age, gender, race, location, native language, occupation, contact information such as mobile numbers, years of experience in a given language, languages spoken, and the like). FIG. 14 illustrates an exemplary user data input screen 1405.

If, for example, a user selects a module at step 124, the system proceeds to that module. FIG. 2a-g illustrates an exemplary embodiment of a learner experience while using an exemplary module 126. Many possible sequences of activities, scope of activities, quantity of activities are possible within the scope of the present embodiments. Further, it is understood that at any step, the learner may be given the option to exit the system, the module and/or the activity at any time or at pre-selected times.

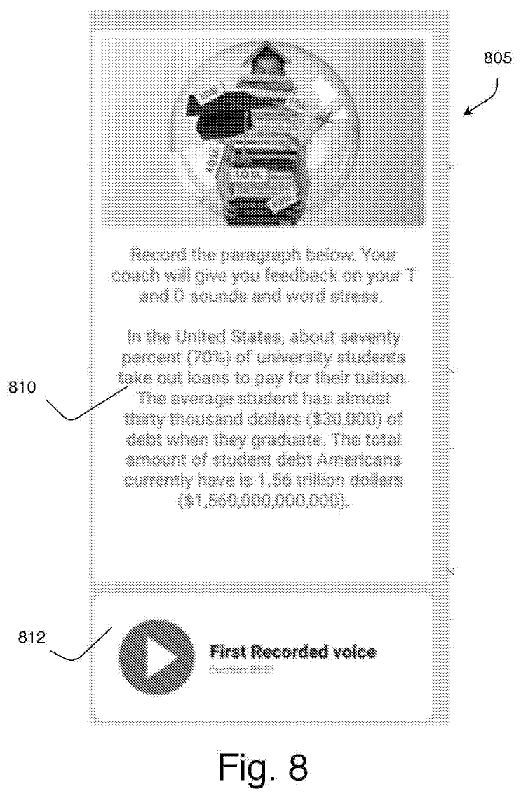

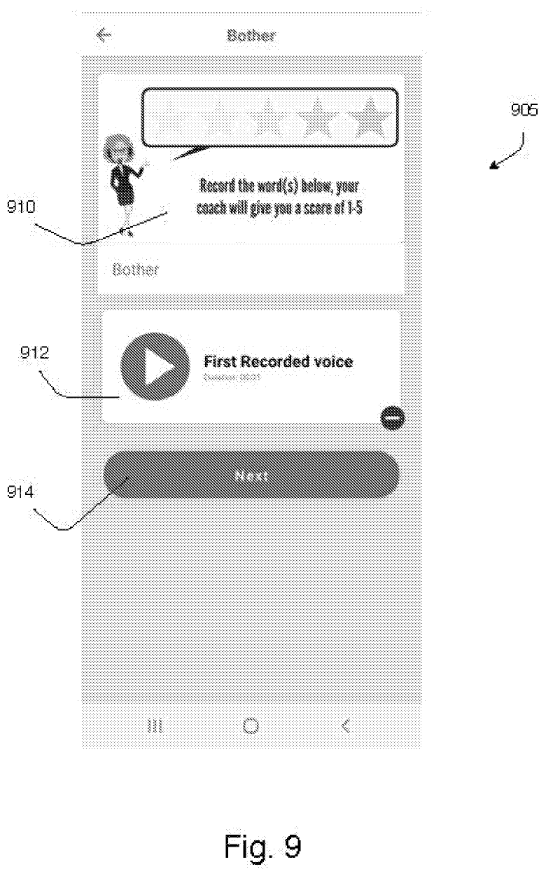

As represented in FIG. 2a, where module ‘m’ was selected, the system begins module 126 by generating a prompt to elicit a language sample in step 210. It should be understood that the word “prompt”, when used in the context of eliciting language samples, means that the system is indicating to the learner what should be included in their language sample. Some examples might include repeating a single preselected word, repeating a pre-determined text of multiple words, and/or answering a preselected question. Samples of such prompts can be seen in FIG. 8 and FIG. 9.

Next, the system prompts a user to create and submit a language sample activates a recording input device, such as a microphone and or camera, and prompts the learner to submit a language sample at step 212 for recording into the system. It is understood that this language sample can be any type of productive language of any length in audio or visual form. It should also be understood that the recording mechanism activated by the system to collect a language sample might include but is not limited to, a microphone, a keyboard, or a camera.

FIG. 8 illustrates an exemplary prompt touch activated screen 805 to receive language input as an audio and/or visual sample from a user on a user device 1556 (See FIG. 15). In FIG. 8 at 810 an exemplary instruction is shown to facilitate a user recording a language sample. At 812 an exemplary recorded language input controller is illustrated to facilitate a user to record and/or play the recorded language sample.

Another illustration of an exemplary prompt to receive a language sample from a user on a user device 1556 at step 210 in FIG. 2a is illustrated in FIG. 9. In FIG. 9 touch activated screen 905 at 910 provides instructions to guide a user on how to record a language sample. Section 912 demonstrates to record and/or play the recorded language sample. Section 914 provides a prompt for the user to navigate to a ‘next’ language sample collection. In some embodiments, when there is no more language sample collection available, section 914 would change its function to ‘send’ to send the user inputs to the server unit 1200 (FIG. 15).

After the system records a language sample at step 212, it prompts the user to indicate if they would like to repeat the process or submit it for analysis in step 214. If the system is prompted to submit (“Yes”), it sends the language sample to a server unit 1200 in step 218. If the system is prompted to repeat the process (“No”), it deletes the sample in step 216 and again shows the user the language sample prompt and activates a recording mechanism from step 212.

After the system sends the language sample to the server unit 1200 in step 218, the system shows the learner educational content in step 220. The educational content shown at step 220 presents the learner with key information to be evaluated while a learner uses the module. For example, if the focus of the module is learning a specific sound, this educational content can, for example, give the learner specific instructions on what to do with their mouth to make that sound. The purpose of showing additional content after collecting a language sample at step 212 is that the system can gather data on the effectiveness of the educational content in teaching the learner a new skill. Educational content might include, but is not limited to, videos, pictures, text, or audio. Specific educational content may also be shown to specific users based on their data. After showing the learner the educational content, the system prompts the learner to select whether they would like to see the content again at step 222. If the system is prompted to show the educational content again (“Yes”), it repeats step 220 and proceed to step 222 on completion. If the system is prompted not to see the content again (“No”) at step 222, it proceeds to the next section of the module to step 224, which initiates a series of interactive practice activities beginning in FIG. 2b. For example, a learner whose data indicates they are a native Spanish speaker can be shown educational content that addresses common pronunciation errors made by Spanish speakers and how to correct them. In another example, a learner whose data indicates they speak with a lisp, they can be shown content related to correcting a lisp.

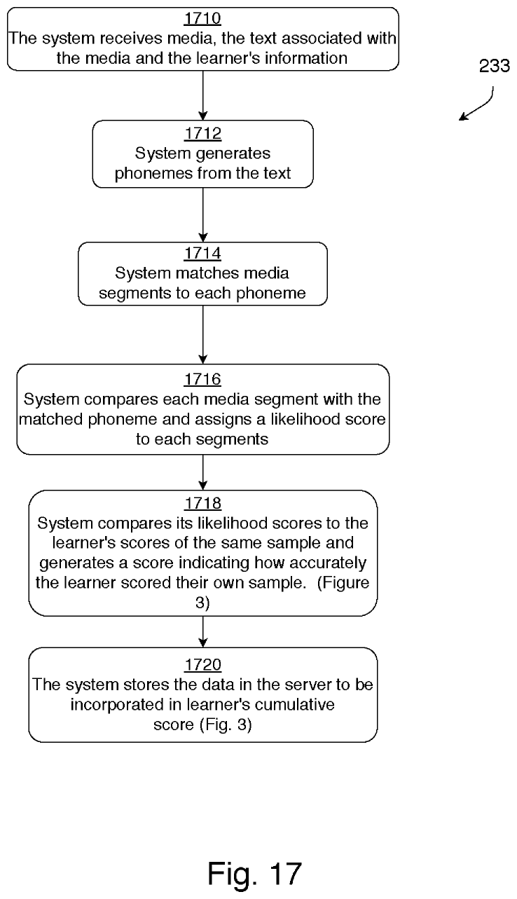

As shown in FIG. 2b, a first exemplary interactive practice activity may be launched at step 226. At step 228, the system generates a pre-made (pre-recorded and stored) language sample, then prompts the learner to create their own language sample for comparison at step 230. The sample selection may be in either a sequence or chosen by the system at random. At step 231, the system prompts the learner to compare their own sample with the pre-made sample to evaluate their own performance based on pre-determined performance indicators at step 232. For example, the system may prompt the learner to generate an audio sample of the word “pronounce,” then prompt the learner to evaluate the correctness of the “p sound” in their own sample by comparing it to the pre-made sample. Then, at step 232, the system prompts the learner to enter a score based on their analysis. At step 233, the system analyzes the learner's language sample and compares the learner's self-given score to a score generated by the system through a process that is illustrated by FIG. 17. Then, in step 234, the system prompts the learner to indicate whether they are satisfied with the sample (“Yes”) or wish to repeat the process (“No”).

If the system is prompted to repeat, it returns to step 230. If the system receives notification that the learner is satisfied with their sample, it checks for more pre-made language samples in step 236. If more samples are available, the system prompts the learner to indicate if they want to practice more in step 240. If yes, the system repeats the process again from step 228. If at step 236 there are no more pre-made language samples left, the system initiates the next practice activity in step 238. If at step 240 the system is prompted not to do more practice, it also proceed to step 238 to initiate the next practice activity, illustrated in FIG. 2c. It is noted that at this step, the learner is typically just evaluating themselves. However, the system may optionally be configured to analyze how accurately the learner is able to self-evaluate, as illustrated by FIG. 17.

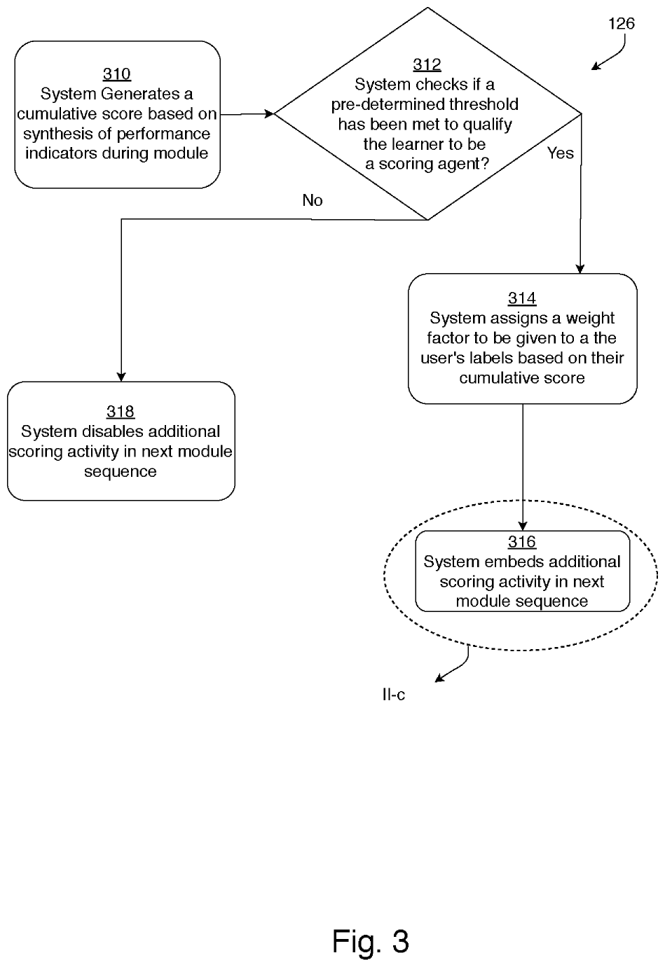

FIG. 17 illustrates one of the processes the system may use to generate a cumulative score for a learner based on their performance throughout the module at step 233. At step 232, the system prompts the learner to score their own language sample by comparing it to a pre-made language sample. Then, at step 233, the system analyzes this recording and analyzes how accurately the learner evaluated their own performance. This analysis begins at step 1710 when the system receives the media and text from the learner's language sample. Then, at step 1712, the system generates phonemes from the text. At step 1714, the system matches media segments to each phoneme. At step 1716, the system compares each media segment with the matched phoneme and assigns a likelihood score to each of the segments based on information from the training database. Then, at step 1718, the system compares the likeliness scored generated from the training database with the learner's score of their own language sample. Using this comparison, the system can generate a score, for example, between 1-10, 0-1, 1-5, and the like that indicates how accurately the learner evaluated their own sample. For example, the system will receive the learner's score between 1-5 of their pronunciation of the “p sound” in the word “pronunciation.” Then, the system will generate a score between 1-5 for that same phoneme and compare it to the learner's entered self-score. Based on how close the learner's score is to the system's score, the system can generate a score between 0-1 that indicates the learner's accuracy in evaluating the language sample. This score will be stored in the server at step 1720 and incorporated into the learner's cumulative score, as illustrated in FIG. 3.

FIG. 2c illustrates a potential next interactive practice activity of the module, which is a quiz section. When the quiz section is launched in step 242, the system generates the first quiz item in step 244, which may include a preselected question and an array of possible answers retrieved from a database within the system of questions, answer choices to be presented to the learner and the correct answer presented to the learner upon their selection. In addition to the predetermined ‘correct’ answer, the system may alternate its selection of predetermined ‘wrong’ answers to present to the learner. Alternatively, the system may provide a text block for the learner to enter an answer on a keyboard or by recording a voice or a video answer. The quiz item selection by the system may be in either a sequence or random.

The system then receives an answer choice from a learner in step 246. In step 248, the system determines if the choice is correct based on a predetermined answer maintained in the system database. If yes, the system generates an affirmation of the correct choice in step 250. If no, the system generates an indication of an incorrect choice in step 252. In either case, the system records the result for summation in step 254.

Then, in step 256, the system checks to see if there are more quiz items available. If yes, the system generates the next question in 241, which leads back to step 246, and the process continues until at step 256 the system finds that no more quiz items are available. When this occurs, the system checks at step 258 if the learner is eligible to be a scorer of other learners' language samples based on the cumulative score generated by the system based on past performance indicators. This process is illustrated in FIG. 3 wherein a learner may become a live scorer within the system (i.e., a scoring agent) if a pre-determined quantity and proportion of correct answers are recorded.

If a learner is not eligible to be a language sample scorer, the system generates quiz results at step 266. Alternatively, the user may also elect to receive quiz results at step 266.

If the learner is an eligible language sample scorer (a scoring agent), the system initiates a scoring activity in which the learner acting as a scoring agent can assign coaching scores to language samples of other learners. This is done anonymously. Thus, at step 260, the system checks if any language samples from other learners are available for scoring. If there are samples available, the system prompts an eligible language sample scorer to assign a score to the language samples based on a pre-determined performance indicator in step 262. Exemplary performance indicators can include but are not limited to, how correctly a phoneme was pronounced in the language sample, how correctly something was written in a language sample, or how closely a native sample resembled the language sample of a native speaker. In step 264, the system saves the labeled data (i.e., the scored language sample) to the server unit with the corresponding learners' cumulative score. This cumulative score indicates to the system the weighting factor that should be given to that learners' data when incorporating it into future likelihood scores. Steps 260, 262, and 264 continue until no more samples are available for scoring or the user exists the system as has been mentioned that can occur at any time during a user's login session. Alternatively, the user may also elect to receive quiz results at step 266.

In one approach, the system calculates the weighting factor based on the percentage of the correct answers in the cumulative generated score for the learner in the quiz section 242. In some other embodiments, the system may use the cumulative generated score, and other available data from the user, such as their native language, location, age, and years of experience with English, and use machine learning analysis to generate a weighting factor.

When no more samples are available for scoring, the system generates the quiz results in step 266, send the results to the server unit, and prompts the learner to indicate whether they wish to repeat the quiz in step 268. If yes, the system repeats the process from steps 244-268. At step 268, when the system is prompted that the learner does not want to repeat the quiz, the system may initiate the next exemplary interactive practice activity in step 270, which is illustrated in FIG. 2d.

FIG. 2d illustrates an exemplary next potential interactive practice activity, which is the machine learning or artificial intelligence (AI) coaching activity, which involves artificial coaching agents using data from machine learned algorithms using voice recognition software such as one sold under the tradename GOOGLE SPEECH TO TEXT. This activity is launched at step 272.

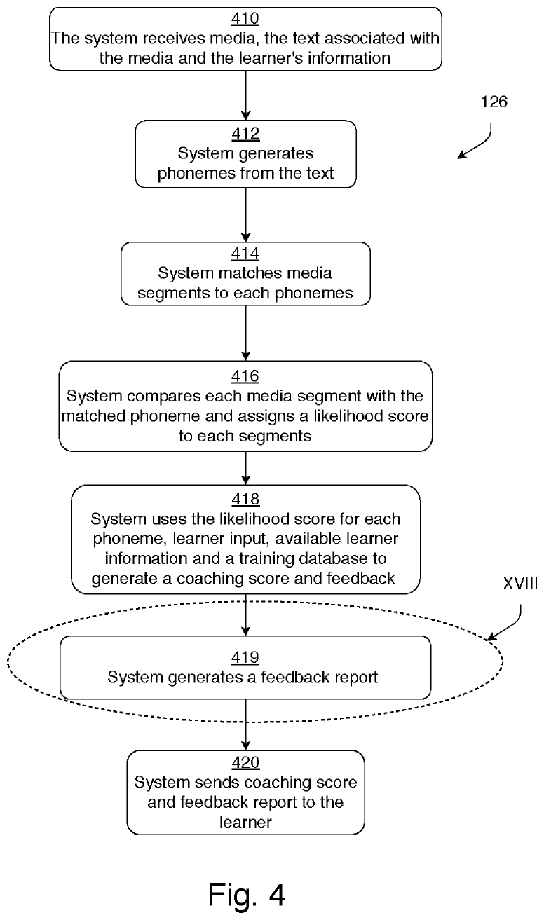

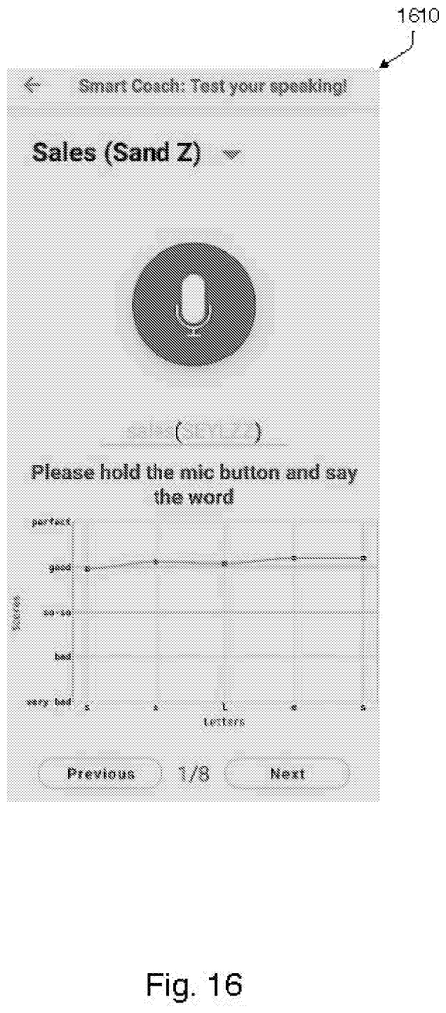

When step 272 is launched, the system proceeds to step 274 and prompts the learner to record a language sample and activates the input device such as the microphone and/or camera. In an exemplary prompt screen 1610, as shown in FIG. 16, the prompt can include but is not limited to asking the learner to record an individual word, a phrase, answer a question verbally, or answer a question in writing. When a language sample is received, the system sends the sample to the server unit 1200 in step 276. The server unit analyzes the sample and generates a report in step 278. It is noted though that as is mentioned herein this function can also be configured to be analyzed in whole or in part on the learner's device as well. This process of analysis is illustrated in greater detail by FIG. 4. In step 280, the system delivers the report to the learner and prompts the learner to indicate if they want to repeat the process for a new analysis. If the learner chooses to repeat, the system returns the learner to step 274 and repeat steps 274-280 until the system receives an indication at step 280 that they learner does not want to repeat that prompt.

When the system receives an indication that the learner does not want to repeat the prompt in step 280, the system checks to see if more prompts are available in step 282. If there are more such prompts available, the system repeats steps 274-282 until there are no more prompts available. When this occurs, the system initiates the next section of the module at step 284, which is illustrated in FIG. 2e.

FIG. 2e illustrates an additional educational content section of the module, which may or may not be included in every module. Educational content might include, but is not limited to, information videos, pictures, text, audio, and the like and combinations thereof. The system launches the additional educational content section and at step 286 and proceeds to step 288 where the system checks if there is additional educational content available.

When the system indicates that additional educational content available at step 288, the system advances to step 290 and illustrates/lists the available content to the learner. Once completed, the system prompts the learner at step 292 to indicate whether they wish to see it again or advance to the next step. When the system is prompted to show content again (“Yes”), it repeats steps 290 and 292. When the system is prompted to advance (“No”), it proceeds to step 294 and activates a system input device and prompts the learner to generate a new language sample related to the additional educational content. When the new language sample is recorded, the system proceeds to step 296 and sends the sample to the server unit, where it analyzes the sample and generates a report, which is delivered to the learner. The process of analyzing the language sample may be as illustrated in FIG. 4 and FIG. 5.

Next, the system proceeds to step 298, where the system prompts the learner to indicate if they want to repeat the process for the same prompt for additional educational content. If the learner chooses to repeat at step 298 (“Yes”), the system repeats the process for the same prompt from steps 294-298. When the system is prompted to continue (“No”), it returns to step 288 to check for additional content. If yes, the system repeats steps 288-298 until there is no additional educational content available. If no, i.e., no additional content available, the system proceeds to step 211 to initiate the next section of the module, which is illustrated in FIG. 2f and initiated at step 213.

FIG. 2f illustrates an additional (and as illustrated, a final) activity within the exemplary module described herein. In this part of the module, a language sample is submitted to a server and delivered to a scoring agent. This section is launched at step 213, where the system proceeds to step 215 to activate the input device and generate a pre-determined prompt for the learner to create a language sample. As shown in FIGS. 8 and 9, this language sample may include but is not limited to an audio or video recording of an individual word, phrase, paragraph, or response to a question, a written language sample, or any combination thereof. Then, once the system receives the language sample, it prompts the learner to indicate if they wish to submit their sample or repeat the process in step 217. When the system is prompted to submit the sample (“Yes”), it sends the language sample to the server unit at step 219. Then, the server unit submits the language sample to a scoring agent at step 221. This process of submitting a language sample to a scoring agent is illustrated in greater detail in FIG. 2g. If (“No”) at Step 217, then the system proceeds to Step 215.

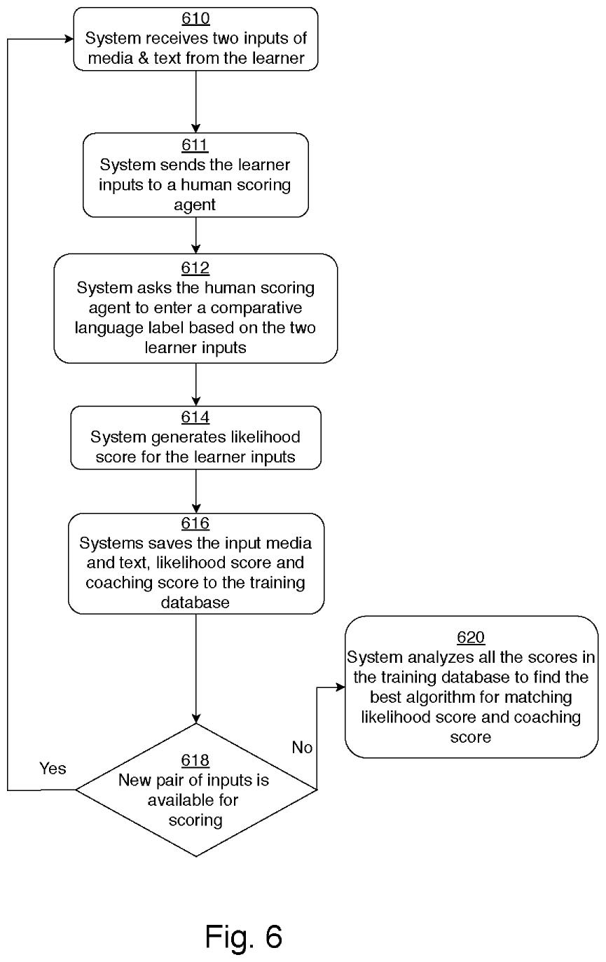

The system next proceeds to step 223, where the system checks for more prompts at step 215. If there are more prompts available (“Yes”), the system repeats steps 215-223 until there are no additional pre-determined prompts (“No”). When this occurs, the system generates a module completion message at step 225. Then the system proceeds to step 227 where the learner is asked to choose if they want to return to select a new module or exit the system. If the system is prompted to continue the next module (“Yes”), it does so by initiating step 229 and returning to step 128 to allow a learner to select a new module. Alternatively, the system at step 229 can just automatically advance to the next module. If the system is prompted not to continue (“No”), the program closes at step 231. In any case, the completion of step 221 initiates the processes described in FIG. 2g and FIG. 6.

FIG. 2g illustrates the process by which a language sample is submitted for scoring by a scoring agent. At step 221, a language sample is sent to the server unit, which submits the language sample to a scoring agent at step 233. At step 235, the system prompts the scoring agent to assign a coaching score to the data from the language sample according to their analysis of performance in pre-determined performance indicators. At step 237, the system prompts the scoring agent to assign a coaching score to each post-lesson assignment based on the level of improvement between the pre-lesson and post-lesson language samples. At step 239, the system sends the coaching scores from the scoring agent and corresponding language samples to the server unit. At step 241 the system sends a report to the learner containing the scoring agent's analysis and sends the learner a notification that feedback has been received.

FIG. 3 illustrates one embodiment of a process by which the system determines a learner's eligibility to qualify to participate in an additional activity, such as qualifying to become a scoring agent and score other learner's activity, determining the other learners' dialect and other of the learner's demographics identified by the system, determining if the learner's mouth movement matches their sound, their providing suggestion to other learner's to improve their language and communication skills, and the like. (See step 258 of FIG. 2c) As shown in FIG. 3, at step 310, the system analyzes all the performance-related data indicators associated with the specific learner, such as how closely their language samples matched correct language samples at step 278, how accurately the learner was able to identify correct language samples at steps 244, 246 and 248, and how correct their language samples were according to a scoring agent at steps 235 and 237. Based on these analyses, the system generates a cumulative eligibility score and assigns it to a learner. The cumulative generated score may be the percentage of the correct answer by the learner. In some other embodiments, the cumulative generated score may be a number between 0 and 1. In some other embodiments, the cumulative generated score may be a label such as excellent, good or fair. At step 312 the system decides if the learner has reached a pre-determined quantitative threshold to be eligible as a scorer. The system may determine if a learner is eligible to be a scorer if that learner is in a top specific percentage of all learners in the system. For example, eligible scorers may need to be in the top 80^{th} percentile of users in the system. In some other embodiments, the system may determine if a learner is eligible to be a scorer if their cumulative score generated by the system is higher than a pre-determined amount. If yes, the system assigns a qualitative weighting factor that is given to that particular factor. At step 316, the system activates the embedded scoring activity in the learner's next module sequence, as shown in FIG. 2c. If at step 312 the system determines a learner is not eligible to be a scorer, the system disables the scoring module in the learner's profile at step 318 until they achieve eligibility.

FIG. 4 illustrates one example of how the system may generate feedback on a learner's language proficiency based on their language sample input. (See e.g., Step 278 of FIG. 2d) At step 410, the system receives a voice or video from the learner and a text. Then the system generates phonemes of the received text at step 412. In another approach, the system uses speech recognition software to generate the text associated with the language sample. In another approach the system uses an agent to input the text associated with the language input.

In some embodiments, the system provides recorded media fora learner to view and/or hear in the form of an image, video, or audio. A concurrent pre-defined text is paired with the media recorded in the system. The learner enters an input as a recorded audio. In some other embodiments the leaner enters an input as a recorded non-mute video of their mouth based on the supplied media. Then the system uses the learner input and the pre-defined text associated with the provided recorded media for analysis in the next steps.

The system then matches each segment of the learner's input with the system generated phonemes at step 414. In another approach, when the system is configured to generate feedback on word stress or sentence stress, the system matches each segment of the language sample with a database of predetermined reference stress model sections. Then, at step 416, the system compares each segment with the matched phonemes and assigns a similarity score to each segment known as likelihood score. Likelihood score is a quantitative score that shows the level of similarity of language sample with the reference language data. The likelihood score may be a number range between 0 and 1. In another embodiment, the system may use a logarithmic likelihood score that ranges between −∞ and ∞

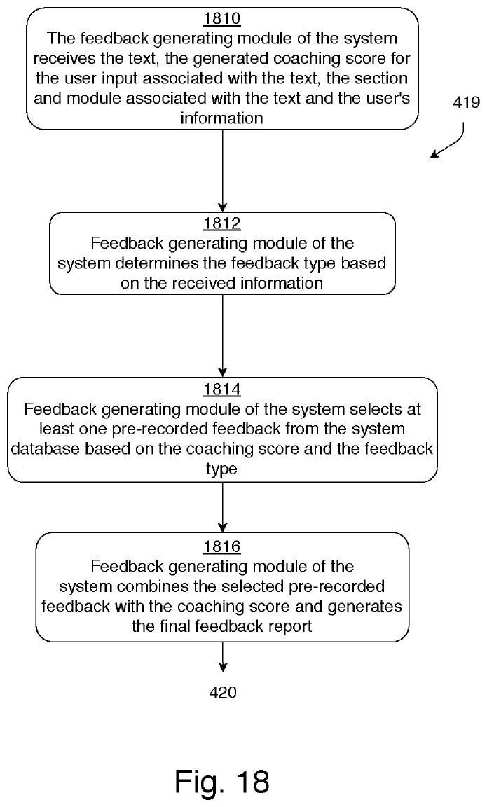

At step 418, the system use the likelihood score, the learner input, input from a training database, and the available information from the learner (including but not limited to native language of the learner, their age, and their gender) to generate the final score known as coaching score. Then, at step 419, the system uses the coaching score with other pre-determined information to generate a feedback report. This process of generating a feedback score is illustrated by FIG. 18.

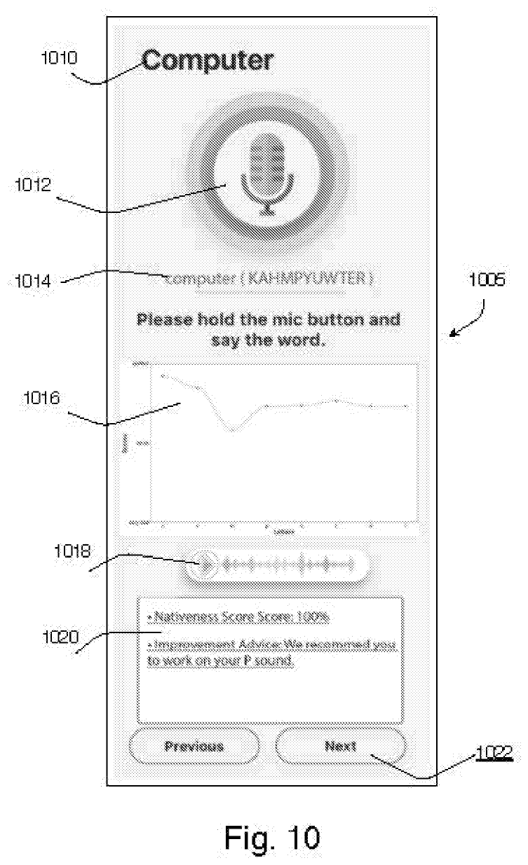

As shown in FIG. 18, the system activated a feedback generating module that uses the coaching score and other information to generate a feedback report to be sent to the learner. At step 1810, the feedback generating module of the system received the test, the coaching score associated with a user input, user data, and an indication of the course module from which the user submission was sent. Then, at step 1812, the system determines the type of feedback that will be sent to the user. For example, in some modules the system may give feedback on individual phonemes while in other modules, the system give feedback on prosodic speech elements such as word stress or intonation. At step 1814, the feedback generating module of the system uses the coaching score and feedback type information to selects a pre-recorded feedback file from the system database. At step 1816, the system combines the selected pre-recorded feedback with the coaching score to generate the final feedback report. An exemplary feedback report can be seen in FIG. 10 as is discussed below. The system then sends the coaching score and the feedback report to the learner at step 420.

It is understood that the coaching score is a quantitative and/or qualitative indicator that represents the level of predetermined level of “correctness” of a measured language parameter, such as (for illustrative purposes only) a quantitative and/or a qualitative indicator that represents the accuracy of a phoneme, word stress, sentence stress, intonation, and/or an indicator of the appropriateness of a phrase in a sentence or that paragraph based on the context. For example, a coaching score can be a number on a scale of 1 to 5 to show the accuracy of each pronounced phoneme in a language sample form a learner. In the mentioned embodiment, a learner with the completely correct pronunciation of a phoneme will receive score 5 for that phoneme. In contrast, a learner who doesn't pronounce that phoneme will receive score 1 for that phoneme. Unlike the likelihood score, the coaching score is calibrated in a way to be understood by humans. For example, when a learner slightly improves their pronunciation, their coaching score for a phoneme may increase from 3 to 3.5, so the coaching score is proportional to the correctness of a language sample on a scale that makes sense for a human being. On the contrary, the likelihood score may not make sense to humans. For example, the likelihood score may follow a logarithmic or exponential scale.

For example, a learner may pronounce a phoneme in two different language inputs with slightly different correctness levels. The system may generate the likelihood score 10 for the first language input and the likelihood score 1300 for the second language input. These two numbers are not proportional to the level of correctness of pronunciation in a way that makes sense to a human. The system then uses the mentioned information and machine learning algorithm to generate a coaching score that is practical to educate a human learner. For example, the system may match the likelihood score 10 to the coaching score 3, and the likelihood score 1300 to the coaching score 3.5, and generate a report with these scores to the user. Another benefit of using a coaching score is to adjust the errors caused by the likelihood score. For example, the user's device microphone noise, and the adjacent phonemes of a specific phoneme may affect the likelihood score of a phoneme and cause errors. The system will use machine learning and the data on the training database to minimize the error and generate a coaching score very similar to the coaching scores generated by scoring agents.

In another embodiment, the coaching score can be a numerical ranking to show the accuracy of pronounced word stress. In another embodiment, a coaching score can be a qualitative indicator to show how appropriate a phrase is in a sentence such as “inappropriate”, “very good” etc. In another embodiment, the scoring agent may provide a score on the learner's mouth movements in the recorded language sample. In another embodiment, the scoring agent may provide a score on at least one of a learner's face movements, body movements, body language, and the like. A coaching score may also include feedback. This feedback is a system generated report sent to the learner, providing analysis such as a verbal or visual explanation about the learner's strengths and weaknesses in the submitted language sample and the ways and techniques for the learner to correct the mistakes and improve the weaknesses of the learner. In another embodiment, the scoring agent may generate a report on at least one of a learner's face movements, body movements, and body language in the recorded language sample. According to one approach, the system can generate the report or alternately, the system can pass on a report made by the coaching agent, or alternatively, a combination of the two depending on the application.

The system can be configured to use machine learning methods to analyze all available information within the system to determine the most accurate coaching score. After generating the coaching score, the system generates feedback based on the coaching score. This feedback can be but not limited to any form of text, audio, or video directly generated by the system or can be premade text or media, which is chosen by the system based on the coaching score.

FIG. 5 illustrates a process that may run automatically in the background as the system is also guiding the learner through a module with the purpose of receiving input from a scoring agent in order to improve the accuracy of the system algorithm. Specifically, FIG. 5 illustrates an exemplary method and the process to collect coaching scores from a scoring agent and analyze them to improve the accuracy of the system's automated scoring algorithm and generate accurate automated coaching scores. At step 510, the system is initiated by receiving a language sample in the form of voice or video and associated text from a learner. The system then sends the language sample acquired in step 510 to a scoring agent in step 511. At step 512, the system requests the scoring agent to provide a coaching score for the received language sample.

Then, at step 514, the system generates likelihood scores for the language sample. At step 516, the system saves the likelihood score and all other collected data to the training database. Other collected data can include but are not limited to the learner's native language, location, age, gender, device model and race. The system checks for additional input to score at step 518. If there is new input available, the system repeats steps 510-518 until there is no new input available for scoring. When this occurs, at step 520, the system analyzes all the scores, language samples and collected learner data in the training database and uses machine learning and neural network to find the best algorithm and parameters for predicting a coaching score based on a learner's input, likelihood score and other available data from a learner. This algorithm is used to generate an automated coaching score, which may be useful when there is no scoring agent available, such as at step 418.

Ultimately as the optimized algorithms are developed over time, the system may need to rely less on the use of live scoring agents. In short, the machine learning allows the system to compare its predicted score to the score of a live scoring agent and based on its comparative analysis of this with all the other recorded variables, determine the accuracy of the automated score. As data is acquired over time, the accuracy of the automated system thus achieves a comparable accuracy to the live scoring agent. The system could also apply these analyses to compare the accuracy of live scoring agents against each other and thus rank the live scoring agents against each other and against the automated system accuracy. This could be used to weight the value of each scoring agent and automated system.

FIG. 6 illustrates another automatic process that could occur automatically within the system as illustrated by FIG. 5. In this instance though, instead of generating a likelihood score based on the learner's language sample, the process in FIG. 6 generates a comparative score to evaluate the learner's progress from before the module began to after the module was completed. Specifically, FIG. 6 illustrates the method and the process of collecting comparative coaching scores from a scoring agent. At step 610, the system is initiated by receiving a pair of language inputs from a learner in the form of voice or video and the associated text. The system sends the language inputs to a scoring agent at step 611. At step 612, the system requests the scoring agent to provide a comparative coaching score based on the two language samples. As an example, the scoring agent may receive a word that the learner pronounced at the beginning of the module, as explained in FIG. 2a, and a word that the learner pronounced after finishing in the module, as explained in FIG. 2f. The system asks for the input from the scoring agent based on these two words. Some examples of this score can be: “the second word is pronounced better”, “the second word has 70% improvement.”

Then, the system generates likelihood scores for the media based on all available data in the server unit at step 614. At step 616, the system saves the likelihood scores to the training database and checks for additional input to score at step 618. If there are new pairs of input available, the system repeats steps 610-618 until there is no new pairs of input available for scoring. When this occurs, at step 620, the system analyzes all the scores in the training database to find the best algorithm for matching likelihood score and coaching score using machine learning and neural networks. The report generated at the step 620 for each language input is similar to the report generated at the step 520.

The system saves all of the language inputs and their associated coaching scores. In addition to the learner's information to the training database. The system uses the training database as an element to train its machine learning algorithms.

FIG. 10 illustrates an exemplary touch screen display prompt 1005 to provide a feedback from the system on a learner language input (See FIG. 2d). At 1010 the prompt illustrates a language sample for the learner to record. In some embodiments, the illustration of the language sample may be in form of media. At 1012 the learner is prompted to record a language sample. At 1014 the prompt illustrates an exemplary language feedback in form of text. In some embodiments, the system may not provide for text feedback. At 1012 the prompt illustrates an exemplary language feedback in form of image or video. In some embodiments the system may not provide image or video feedback. In section 1020 exemplary instructions and information are shown for the learner based on their language input. In some embodiments 1020 is in form of text, in some other embodiments, 1020 is in form of media. The learner can navigate to the next and previous language samples by touching 1022.

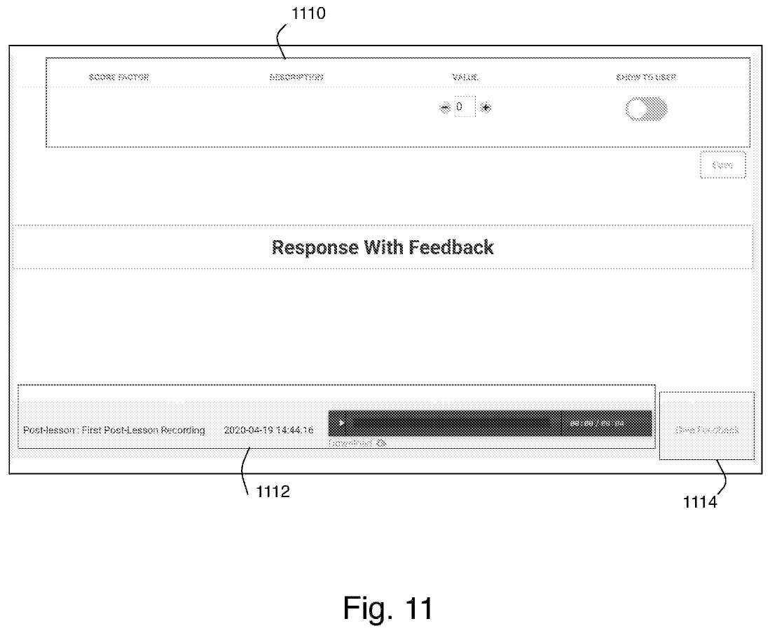

FIG. 11 illustrates an exemplary user interface for a scoring agent. The scoring agent may review, listen to and/or watch the received learner language sample input in section 1112. At 1114 the scoring agent is prompted to input feedback on each language sample. In some embodiments, 1114 is text. In some other embodiments, 1114 may be media. At 1110 the scoring agent is prompted to input quantitative feedback on the language samples.

While the invention has been described in conjunction with specific embodiments, it is evident that many alternatives, modifications, and variations will be apparent to those skilled in the art in light of the foregoing description. Accordingly, the present invention attempts to embrace all such alternatives, modifications, and variations that fall within the spirit and scope of the appended claims. Accordingly, the specification and drawings are to be regarded in an illustrative rather than a restrictive sense. Throughout this specification and the drawings and Figures associated with this specification, numerical labels of previously shown or discussed features may be reused in another drawing Figure to indicate similar features. It is also understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

We claim:

1. A method for enabling improved proficiency of speech, comprising the steps of:
receiving language sample input from a regular user;
facilitating analysis of the language sample input by implementing a machine learning model trained using a scoring agent based on a pre-determined set of language parameters to generate a coaching score;
receiving a coaching score input from the scoring agent analysis of the user's speech proficiency;
generating a report to the user resulting from applying the previously-trained machine learning model based on the score, wherein the report is configured to enable the user to improve speech proficiency.

2. A method for enabling improved proficiency of speech, comprising the steps of:
receiving language sample input from a regular user;
facilitating analysis of the language sample input by a scoring agent based on a pre-determined set of language parameters to generate a coaching score;
receiving a coaching score input from the scoring agent analysis of the user's speech proficiency;
generating a report to the user based on the score, wherein the report is configured to enable the user to improve speech proficiency;
wherein the scoring agent is at least one of a human, a regular user, and a machine with the ability to analyze the user audio input based on the set of language parameters.

3. The method of claim 2, wherein the language parameters comprise at least one of accuracy of a phoneme, word stress, sentence stress, intonation, and an appropriateness indicator of a phrase in a sentence or that paragraph based on the context.

4. The method of claim 2, wherein the step of receiving a language sample, is one of recording a repeated single preselected word, repeating a pre-determined text of multiple words, and answering a preselected question using at least one of a camera and a microphone.

5. The method of claim 2, further comprising the steps of:
displaying preselected education content in response to receiving a language sample from the user;
initiating a module to provide a user educational content; and
initiating a module to provide a user practice activities.

6. The method of claim 2, further comprising the steps of:
launching a preselected practice activity comprising the steps of playing a preselected language sample to a user;
prompting user to record a comparable language sample; and
facilitating a user to compare their sample with the preselected sample.

7. The method of claim 2, further comprising the steps of:
launching a preselected quiz activity comprising the steps of
generating at least one preselected quiz item which includes a question and an array of possible answers;
receiving a user's response to the quiz item;
comparing the response with the answer in a system database;
recording the response; and
allowing a user to become a scoring agent within the system if a pre-determined quantity and proportion of correct answers are recorded.

8. The method of claim 2, wherein the scoring agent is a machine learning algorithm that comprises the steps of:
analyzing the language sample;
generating and providing a report of the analysis to the user; and
allowing the user to record a new language sample for a new analysis for the user generates a report and gives the user an option to repeat the language sample.

9. The method of claim 2, wherein the facilitating analysis of the language sample input by a scoring agent based on a pre-determined set of language parameters includes the steps of:
scoring agent assigning a coaching score to the data from the language sample according their analysis of performance in pre-determined performance indicators;
the scoring agent assigning a coaching score to each post-lesson assignment based on the level of improvement between the pre-lesson and post-lesson language input samples of at least one of the same context and same word; and
the scoring agent providing the user a report to the user containing the scoring agent's analysis the scoring agent notifying the user that feedback has been provided.

10. The method of claim 2, further comprising the step of
qualifying a user to become a scoring agent by reaching a quantitative pre-determined threshold of performance-related data; and
assigning a weighting factor to a scoring agent who has reached the pre-determined threshold of performance based on the value (high or low) of their cumulative score beyond reaching the threshold.

11. The method of claim 2, wherein the step of receiving language sample input from a regular user comprises at least one of the steps of:
generating phonemes from a language sample received as a written text;
using speech recognition software to generate the text associated with the language sample; and
providing a scoring mechanism agent to input text associated with the language sample.

12. The method of claim 2, wherein generating the coaching score comprises analysis of
a likelihood score of each phenome,
user input,
input from a training database, and
demographic information provided about the user.

13. The method of claim 12, wherein the provided demographic information of the user includes at least one of native language of the user, age, and gender.

14. The method of claim 2, further comprising the step of improving coaching scores system-wide by within a training database comparing the user input, system generated likelihood score and coaching score to determine best algorithm for matching likelihood score and coaching score.
